(19) United States
(12) Patent Application Publication
(10) Pub. No.: US 2004/0036290 A1
(43) Pub. Date: Feb. 26, 2004

(54) Connector piece for flexible plastic conduits

(76) Inventors: Jurgen Bock, Shinei (JP); Herbert Frisch, Goppingen (DE)

Correspondence Address: Charles R Hoffmann, Hoffmann & Baron, 6900 Jericho Turnpike, Syosset, NY, 11791, US

(21) Appl. No.: 10/344,818

(22) PCT Filed: Oct. 10, 2001
(86) PCT No.: PCT/EP01/11685

(30) Foreign Application Priority Data
Oct. 31, 2000 (DE) 100545599

(51) Int. Cl. F16L 17/00

(52) U.S. Cl. 285/343

(57) ABSTRACT

A connection member for flexible fluid plastic lines (11), whose wall contains at least one electrical line strand (13). A non-radially symmetrical receiving socket (15) adapted to the cross section of the plastic line (11) serves to receive (11) it. At least one electrical contact spike (22) is so arranged at the floor of the receiving socket (15) that on insertion of the plastic line (11) into the receiving socket it aligns with the at least one electrical line strand (13) and bites into same, the at least one contact spike (22) being electrically connected with at least one electrical connection cable (29) and/or at least one electrical connection contact arrangement of the connection member. Instead of electrical line strands as an alternative or in addition light guides may be present, in the case of which the electrical contact spikes are replaced by light transmitters or optical transducers. By simple insertion of the plastic line (11) the fluid and electrical or, respectively, optical connections are then produced automatically.

The invention relates to a connection member for flexible plastic fluid lines, whose wall contains at least one electrical line strand, a receiving socket, which is radially asymmetrical being provided, which is adapted to the cross section of the plastic line, for the latter.

In the case of such a connection member as disclosed in the German patent publication 19,827,883 A1 for making contact with the at least one electrical line strand in the wall of the plastic line an incisive contact member is caused to bite from the side into the plastic line, that is to say perpendicularly to the longitudinal direction thereof until it makes electrical contact with one such electrical line strand. Accordingly for making contact a second working emboidment is required in the case of a second line strand and in the case of a plurality of line strands, a third, fourth etc working operation may be required for making contact. This means that it is more difficult to make reliable contact in such a case because the incisive contact member must move a certain distance through the plastic material before it reaches the electrical line strand. In this respect there is a danger of the contact member's being deflected by irregularities in the material so that no reliable electrical contact is produced. Furthermore, the incisive contact members must themselves be contacted again following the insertion operation and provided with an electrical connection cable or plug, something which constitutes additional working steps.

One object of the present invention is to improve such a connection member so that the connection with an fluid plastic line, which has electrical line strands, may be performed in a simpler and more reliable manner.

This object is to be achieved by a connection member having the features of claim 1.

A particular advantage of the connection member in accordance with the invention is that by simply inserting the fluid plastic line into the receiving socket the electrical connections themselves are produced automatically, if a plurality of electrical line strands is present in the wall of the plastic line. An additional or later production of the electrical connections is completely unnecessary. Since on insertion of the plastic line into the receiving socket the contact spikes dig or bite directly into the line strands, a reliable electrical connection is ensured, more particularly since the contact spikes bite into the line strands in the longitudinal direction and accordingly define a contact path which is longer than with transverse insertion. More particularly in the case of a large number of line strands in the wall of the plastic line there is a particularly distinct simplification of the electrical connections.

The features defined in the dependent claims render possible advantageous further developments of and improvements in the connection member as claimed in claim 1.

The receiving socket will conveniently possess or substantially consist of a piece of pipe which is arranged in parallelism to the contact spike and extends into the fluid passage of the plastic line on insertion thereof. On slipping the plastic line over the piece of pipe there is on the one hand the formation of a sealing fluid connection while on the other hand such piece of pipe serves to center and align the plastic line and accordingly renders possible reliable positioning in relation to the contact spike or spikes.

For mechanically fixing in place it is an advantage to use a clamping fixing means, which more particularly is in the form of a clamping screw means. The clamping screw means may in an advantageous manner comprise a screw thread around the receiving socket and a corresponding union nut, a wedge member, which is able to be moved axially along an oblique face by the union nut serving for clamping the plastic line in place, more particularly between the piece of pipe and the wedge member. On screwing on the union nut there is then not only the desired clamping action, but in addition the plastic line is thrust into the receiving socket so that the electrical contact between the contact spikes and the line strands is improved by compaction of the material of the hose cable (contact thrust by way of the material of the hose cable).

In accordance with an advantage embodiment the flexible wedge member is designed in the form of a clamping ring and possesses an inner form corresponding to the outer form of the plastic line, the outer diameter tapering like a wedge toward the floor of the receiving socket. This means that owing to the clamping screw effect in conjunction with suitable sealing means there is at the same time a water proof connection.

The receiving socket is connected by way of an internal duct arrangement with at least one further fluid connection means and/or a fluid actuator, there being a large number of possibilities of variation and different design here. Preferred embodiments in this case include the design of the at least one further fluid connection point as a further receiving socket for a corresponding plastic line (branch) and/or the design in the form of a fluid connection screw means for screwing into a fluid power means or for the connection of a fluid line with or without an electrical line strand and/or the design as a connection point for a pressure sensor. The various different possibilities may be selected as different types and in different numbers.

The electrical connection contact arrangement may conveniently be designed in the form of an electrical plug or plug connector or a plug connection or as a connection screw means for an electrical cable, there being here again numerous possibilities of variation as regards the type and number thereof.

The electrical connection cable may with advantage also be connected with a sensor and more particularly a position sensor for detecting the position of the piston, or a plug or with a plug or plug connector. In the case of a position sensor same will be permanently molded in place together with the electrical connection cable. Accordingly using two plug or screw connections with a piston and cylinder arrangement it is possible for the fluid connections and the sensor connections to be produced, which then only have to be fixed on the cylinder.

In accordance with an advantageous design the electrical connection cable may also be connected with a face mounted bus station or a bus plug for a data bus.

The invention is not limited to flexible plastic lines whose wall has at least one electrical line strand and in fact extends to connection members for plastic lines in whose wall at least one light guide is provided in addition or as an alternative. In the case of one light guide instead of a contact spike there is a light transmission means or optical transducer on the floor of the receiving socket. The above mentioned clamping fixing means has, in the case of such a design, the advantage that during screwing the light guide or guides are thrust against the light transmitting means or the optical transducer so that satisfactory light transmission is ensured. The sealing action due to the flexible wedge member then prevents soiling thereof, which might hinder the transmission of light.

The connection cable is in such a design designed in the form of an electrical and/or optical connection cable, and furthermore the connection contact arrangement is embodied in the form of an electrical and/or optical connection contact arrangement.

The working examples of the invention are illustrated in drawings and described in more detail in the ensuing account.

FIG. 1 shows a first embodiment of a connection member with a molded on connection cable and a sensor, in the case of which one fluid plastic line having three electrical line strands is plugged in the wall as seen in longitudinal section.

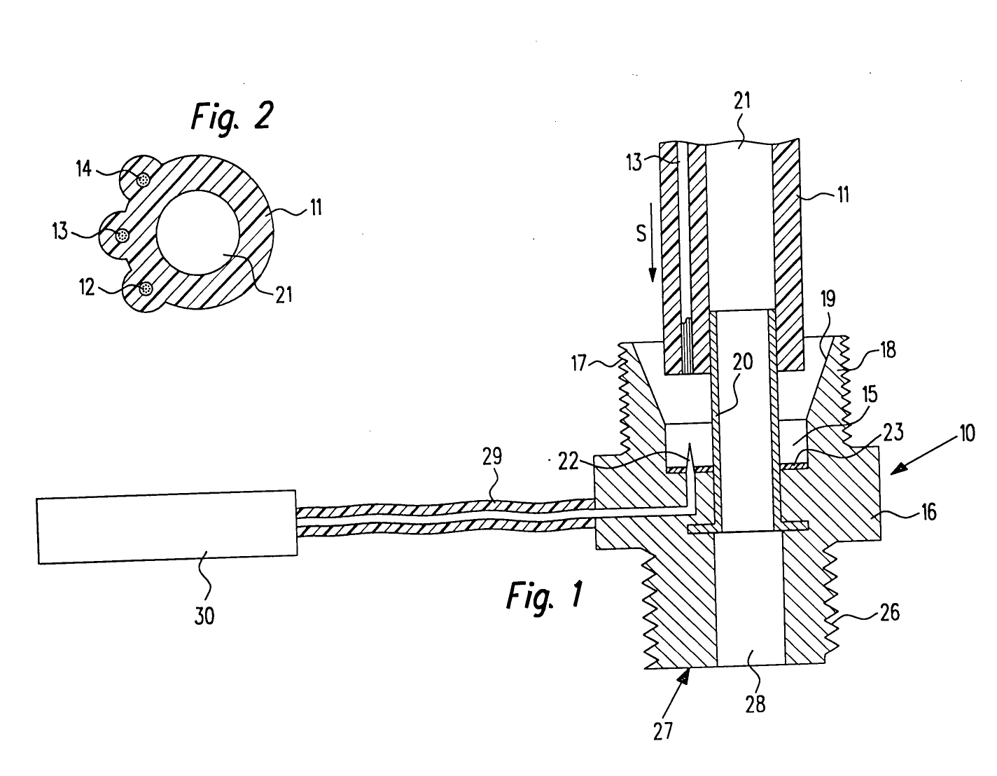

FIG. 2 shows a cross sectional representation of the fluid plastic line.

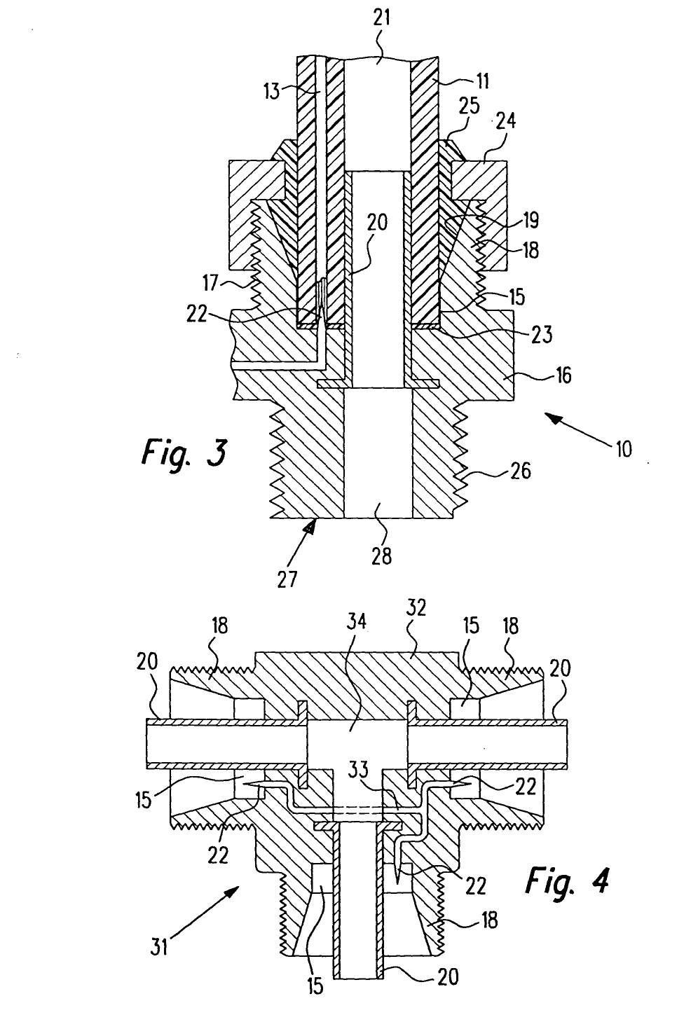

FIG. 3 shows the connection member in accordance with the first working embodiment with the plastic line completely plugged in and secured by a clamping screw means.

FIG. 4 shows a second embodiment of a connection member designed in the form of a branch, in longitudinal section.

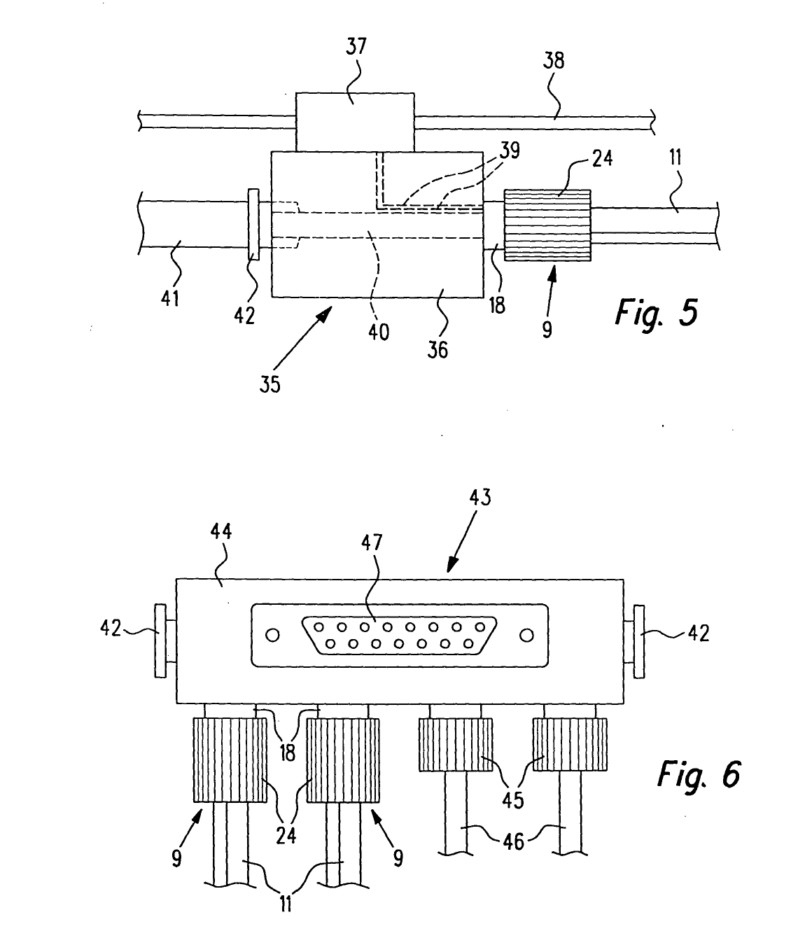

FIG. 5 shows a third embodiment of a connection member with a face mounted bus station as seen from the side.

FIG. 6 shows a fourth embodiment of a connection member, which is designed as a multiple distributor having a multipole plug socket as seen from the side.

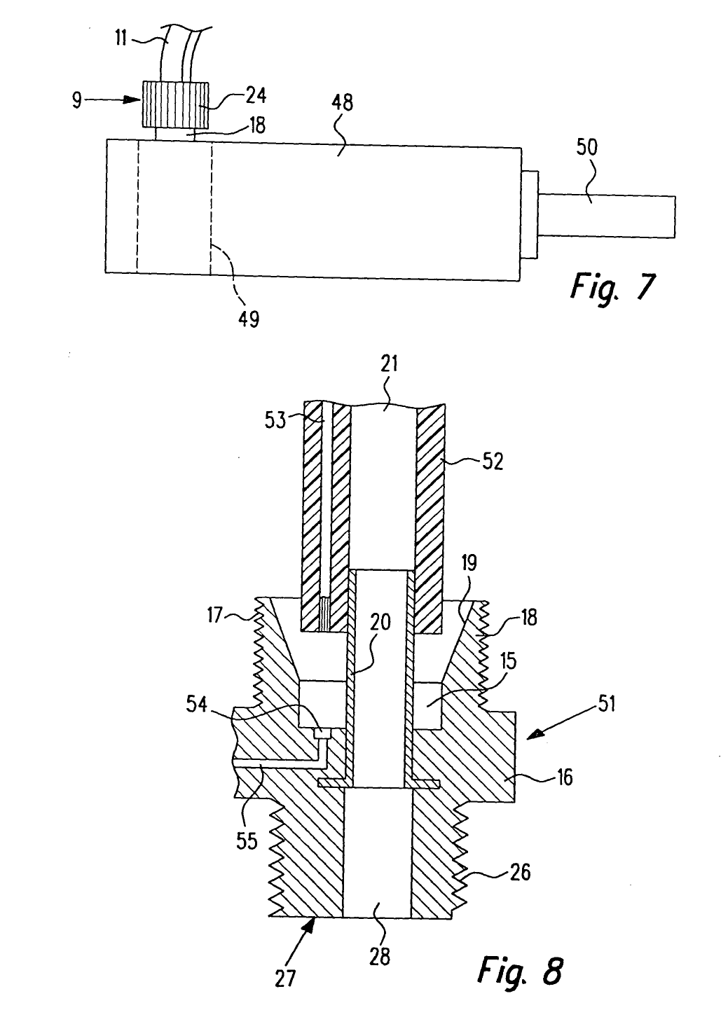

FIG. 7 illustrates a fifth working example of a connection member designed in the form of a connection screwing means and which is connected with a power cylinder.

FIG. 8 shows a sixth example of a connection member for optical signal transmission in longitudinal section.

The connection member 10 represented in FIGS. 1 and 3 as a first working example of the invention essentially serves for connection with a flexible fluid plastic line 11, in whose wall three electrical line strands 12 through 14 extend, which are for example in the form of fine wire strands.

The plastic line 11 has a non-radially symmetrical cross section so that insertion into a receiving socket 15 with the cross section of the principal body 16 of the connection member 10 is only possible with a certain angular alignment. The receiving socket 15 is in this case surrounded by a tube-like wall portion 18, which has a male screw thread 17, of the principal body 16. A part, which adjoins the portion of the receiving socket 15, of the wall portion 18 is tapered toward the free axial end so that at its inner side a conical oblique face 19 is formed. The receiving socket 15 is delimited in the radially inward direction by a piece 20 of pipe, which is anchored on or in the principal body 16 in a sealing manner or is molded on it, such piece 20 extending in the axial direction past the free end of the wall portion 18. The outer diameter of the piece 20 of pipe is in this case slightly larger than the inner diameter of a fluid duct 21 in the interior of the plastic line 11.

Electrical contact spikes 22 extend from the floor of the receiving socket 15 in parallelism to the piece 20 of pipe into the receiving socket 15, the number and arrangement of the contact spikes 22 being the same as the number and arrangement of the line strands 12 through 14 in the plastic line 11 so that on insertion of the plastic line 11 into the receiving socket 15 the contact spikes 22 are driven into the line strands 12 through 14 and produce an electrically conducting connection as is indicated in FIG. 3. Owing to the particular section of the view only the contact spike 22 in contact with the center line strand 13 will be seen. Here there is a sealing washer 23 is arranged between the floor of the receiving socket 15 and the end face of the plastic line 11.

For fixing the inserted plastic line 11 in the receiving socket 15 use is made of a union nut 24 able to be screwed on the screw thread 17, a flexible elastic clamping ring 25 being able to be slid axially through the nut 24 like a gripping tongs. The outer form of this clamping ring 25 corresponds to the outer form of the plastic line 11, whereas the outer form of such clamping ring 25 is, at least adjacent to the conical oblique face 19 of the wall portion 18, a complementary conical face so that on screwing up the union nut 24 the clamping ring 25 is thrust by a wedging the plastic line 11 and presses same firmly between itself and the piece 20 of pipe. Then during screwing up the union nut 24 a force will act by way of clamping ring 25 on the plastic line 11 in the direction S of plugging, by which the plastic line 11 will be thrust against the floor of the receiving socket 15 and accordingly against the sealing washer 23. Simultaneously the contact spikes 22 will bite even more deeply into the plastic line 11 and, respectively, the line strands 12 through 14, if they have not already moved as far as they will go during insertion. Additionally the compacting force on the elastic material of the plastic line means that the contact pressure is increased.

As a modification of the illustrated working embodiment instead of the clamping screw means it is possible for other known clamping or detent connections or female screw means to be employed. In the simplest case for example only the piece 20 of pipe could be provided on its outer face and/or on the wall portion 18 with annular holding projections for fixing the inserted plastic line 11. Such holding projections could also be utilized in addition in the already described working example.

The end portion, axially opposite to the wall portion 18, of the principal body 16 adapted as a screw means for screwing in a sealing manner into a fluid power device such as a valve, a power cylinder or the like. For this purpose such tubular screwing portion or threaded portion 27 is provided with a male thread 26, an internal duct 28, which extends from the end side as far as the piece 20 of pipe, producing the fluid connection.

As shown in FIG. 1 an electrical cable 29 is mounted or molded peripherally on the principal body 16 and produces the electrical connection between a sensor arrangement 30 and the contact spikes 22. If the sensor arrangement 30 only requires two conductors for the signal transmission the cable 29 may be made with two cores instead of three cores so that one of the contact spikes 22 is not connected. The electrical cable 29 may be molded in a sealing manner both on the sensor arrangement 30 and also on the principal body 16. Such a sensor arrangement serves for example for detection of position, for detection of pressure or for detection of temperature. In this case the sensor arrangement 30 comprises conventional sensors for the respective type for data handling, as for instance Hall elements for detection of position or other sensors responsive to magnetic and/or electrical fields.

Instead of a molded on electrical cable 29 the connection means may also naturally be in the form of an electrical plug or screw connection. Furthermore, in an alternative design it is also possible for a plurality of electrical cables 29 to be attached to, molded on or connected by way of several plug or screw connections with the principal body 16 in order to for example to connect a plurality of sensor arrangements or other devices with the line strands 12 through 14 in the plastic line 11.

The connection member 31 depicted in FIG. 4 as a second working embodiment constitutes a branch for the electrical and fluid power connection of three plastic lines 11 with one another. A principal body 32 has, in accordance with the first working embodiment, three wall portions 18 with three receiving sockets 15 and three pieces 20 of pipe, the contact spikes 22 of each receiving socket 15 being connected electrically by connection lines 33 in the principal body 32. Accordingly a T-like duct arrangement 34 connects the three pieces 20 of pipe in fluid conducting manner with each other. The three union nuts 24 necessary and the three clamping rings 25 are omitted from the figure for simplification. Instead of the three connections or, respectively, receiving sockets for the three plastic lines 11 the second embodiment may be so modified that only two receiving sockets 15 (which are arranged in line or at an angle in relation to each other) or furthermore a larger number of corresponding receiving sockets 15 are provided, dependent on how many plastic lines 11 are to be connected with one another.

The connection member 35 presented as a third working embodiment of FIG. 5 possesses a principal body 36, on which a bus station 37 of a data bus 38 is mounted, as for example plugged on screwed in place. As an alternative to this a connection means for a data bus, such as a bus plug, could be provided. A plug connection 9, designed in accordance with the first or second working example, (wall portion 18 and receiving socket 15) for a plastic line 11 is molded on the principal body 36. The electrical connection of the three contact spikes 22 of the connection 9 with the bus station 37 takes place by way of diagrammatically indicated internal lines 39. Furthermore, an internal fluid duct 40 extends from the plug connection 9 as far as the opposite side of the principal body 36, where a fluid line 41 without internal electrical conductors is connected by way of a conventional screw member 42 with the internal fluid duct 40.

As a modification of the third working embodiment the number and arrangement of the plug connections 9 and/or the screw members 42 may also be varied. For instance, only plug connections 9 may be provided. Furthermore instead of the bus station 37 a different electrical instrumentality, such as a sensor, a solenoid valve or a plurality of electrical device, may be provided.

The connection member 43 depicted in FIG. 6 as a fourth working example is designed in the form of a multiple distributor. An elongated principal body 44 possesses two end faces and two plug connections 9, two screw member 42 at the two end faces and two plug connections 45 for electrical cables 46 having several cores. These plug connections 45 are similar to the plug connections 9 and, respectively, the connection member 10 in design, there being the difference that the piece 20 of pipe and the inner duct 28 are omitted in the figure. Owing to not having the fluid duct the receiving socket 15 may be made with smaller dimensions, but does not have to be, like the electrical cable 46, radially symmetrical so that in insertion of the electrical cable 46 the contact spikes may bite into the corresponding cores of the cables 46.

On a further outer side of the principal body 44 an electrical multipole plug socket 47 is provided. The electrical line strands in the plastic lines 11 and the cores in the electrical cables 46 and connected with each other and/or with the connections of the multipole plug socket 47 in the desired fashion internally in the principal body 44. Furthermore, the fluid connections of the two screw members 42 and of the two plug connections 9 in the principal body 44 are connected by way of internal fluid ducts with one another. In the case of this working embodiment as well the number and arrangement of the connections can be varied, it being possible for a different multiple plug socket or a different electrical connection contact arrangement to be present instead of the multipole plug socket 47.

In the case of the fifth working embodiment illustrated in FIG. 7 a plug connection 9 is arranged on a power cylinder 48. This power cylinder 48 comprises at least one internal solenoid valve 49, which may be operated by way of the line strands in the plastic line 11. It is a question in this case of for example a 5/2 or 5/3 way valve. Accordingly the piston or, respectively, the piston rod 50 of the power cylinder 48 may be shifted in the two opposite operating directions. The supply of fluid under pressure is in this case also by way of plastic line 11 so that in all only one single plastic line 11 and one single plug connection 9 are necessary.

Dependent on the number of the line strands in the plastic line 11 it is possible for signals from sensors (not illustrated) in the power cylinder 48 to be transmitted by way of the plastic line 11. Here it is possible for example for a bus station to be comprised in the power cylinder 48.

In accordance with an alternative form of the fifth working example a different fluid power device, as for example a linear motor, a valve cluster or the like, may be present instead of a power cylinder 48.

The connection member illustrated in FIG. 8 as a sixth embodiment of the invention is substantially similar to the connection member 10 described as the first embodiment, similar or substantially similar components and parts being provided with the same reference numerals and not being described over again. Differing from the first working example in this case a plastic line 52 having a suitable cross section is provided, in whose wall instead of electrical line strands 12 through 14 now light guides 53 are arranged. On the floor of the receiving socket 15 the contact spikes 22 have their placed taken by light transmitters 54, which after insertion of the plastic line 52 make an optical connection with the end faces of the light guides 53. The electrical lines connected with the contact spikes 22 and extending in the interior of the principal body 16 have their place taken by correspondingly extending internal light guides 55. The manner of operation of the sixth working embodiment depicted in FIG. 8 is basically the same as that of the first working example, there only being a replacement of electrical signal transmission by optical signal transmission.

As a modification of the sixth working embodiment and as a simpler design the light transmitters 54 could also be omitted so that the light guides 53 in the plastic line 52 would make direct optical contact with the internal light guides 55. As an alternative to this the light transmitters 54 could be replaced by optical transducers so that here optical signal would be converted into electrical signal and the internal light guides 55 could again be replaced by electrical lines.

In principle hybrid designs would also be possible combining features of the first and sixth embodiments, that is to say a plastic line could contain both electrical line strands and also light guides, corresponding contact spikes and light transmitters or, respectively, optical transducers being arranged in the receiving sockets 15. For instance, one light guide could be provided for the signal transmission and two electrical line strands could be provided for electrical amplifiers and, respectively, for power supply.

The principles of the sixth working example depicted in FIG. 8 or of hybrid embodiments combining features of the first and sixth working embodiments may naturally be applied to the remaining working embodiments, as well the electrical lines described or line strands can be partially or completely replaced by light guides.

1. A connection member for flexible plastic fluid lines (11), whose wall contains at least one electrical line strand (12 through 14), comprising a receiving socket (15), which is radially asymmetrical, which is adapted to the cross section of the plastic line (11), for the latter, at least one electrical contact spike (22) on the floor of the receiving socket (15), such contact spike (22) being so arranged that on insertion of the plastic line (11) into the receiving socket (15) it is aligned with the at least one electrical line strand (12 through 14) and bites into same, the at least one contact spike (22) being connected electrically with at least one electrical connection cable (29) and/or with an electrical connection contact arrangement (47; 22 and 33).

2. A connection member for flexible plastic lines (52) whose wall contains at least one light guide (53), comprising a non-radially symmetrical receiving socket (52), adapted to the cross section of the plastic line (52) for same, at least one light transmitter (54) or optical transducer on the floor of the receiving socket (15), which is so arranged that on insertion of the plastic line (52) into the receiving socket (15) it aligns with the light guide (53) and produces an optical connection, the at least one light transmitter (54) or optical transducer being connected with at least one electrical or optical connection cable (55) and/or at least one electrical or optical connection contact arrangement of the connection member.

3. The connection member as set forth in claims 1 and 2 for plastic lines (11; and 52), whose wall contains both at least one electrical line strand (12 through 14) and also at least one light guide (53), characterized in that both at least one contact spike (22) is provided for contacting the at least one electrical line strand (53) and also at least one light transmitter (54) or optical transducer is provided for making optical contact with the at least one light guide (53).

4. The connection member as set forth in any one of the preceding claims, characterized in that the receiving socket (15) possesses a piece (20) of pipe aligned in the plugging direction (S) and adapted to bite on insertion of the plastic line (11; and 52) into the fluid duct (21) thereof or essentially consists of such piece (20) of pipe.

5. The connection member as set forth in any one of the preceding claims, characterized in that a clamping holder means is provided holding a plastic line (11; and 52) inserted into the receiving socket (15), such clamping means being more particularly designed in the form of a clamping screw thread means.

6. The connection member as set forth in claim 5, characterized in that a wall portion (18) annularly surrounding the receiving socket (15) with a screw thread (17) is provided and also a corresponding screw element (24), more particularly a union nut, is provided, a wedge member (25), which can be moved by the screw element (24) axially along an oblique or circularly conical face, being provided for clamping the plastic line (11; and 52) in place, more particularly for clamping same in place between the piece (20) of pipe and the wedge member (25).

7. The connection member as set forth in claim 6, characterized in that the flexible wedge member (25) is designed in the form of a clamping ring and possesses an inner form corresponding to the outline of the plastic line (11; and 52), the external diameter tapering like a wedge or like a circular cone toward the floor of the receiving socket.

8. The connection member as set forth in any one of the preceding claims, characterized in that the receiving socket (15) is connected by way of an internal duct arrangement with at least one further fluid connection point (9; 27; and 42) and/or a fluid actuator (48).

9. The connection member as set forth in claim 8, characterized in that the at least one fluid connection is in the form of a further receiving socket (15) for a corresponding plastic line (11; and 52) and/or as a fluid connection screw means (42) for screwing into a fluid power device or for connection of a fluid line (41) with or without an electrical line strand or light guide and/or as a connection point for a pressure sensor.

10. The connection member as set forth in any one of the preceding claims, characterized in that the electrical and/or optical connection contact arrangement is in the form of an electrical and/or optical plug or plug connector or plug connection (47) or connection screw means (45) for an electrical cable (46) or a light guide.

11. The connection member as set forth in any one of the preceding claims, characterized in that the electrical or optical connection cable (29 is connected with a sensor (30), more particularly a position sensor, to detect the position of a piston, or a plug or a plug connector.

12. The connection member as set forth in claim 11, characterized in that the sensor (30) in the form of a position sensor and the electrical or optical connection cable (29) are permanently molded on.

13. The connection member as set forth in any one of the preceding claims, characterized in that the electrical or optical connection cable is connected with a fitted on bus station (37) for a data bus (38).
